(19) United States
(12) Patent Application Publication
(10) Pub. No.: US 2009/0012959 A1
(43) Pub. Date: Jan. 8, 2009

(54) Method, Apparatus and Computer Program Product for Providing Presentation of a Media Collection

(75) Inventors: Risto Ylivainio, Vacouver (CA); Neil McDewar, Vancouver (CA); Vesa Palomaki, Masala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/774,108

(22) Filed: Jul. 6, 2007

(51) Int. Cl. G06F 17/30; G06F 3/048

(52) U.S. Cl. 707/7; 715/763; 707/E17.009

(57) ABSTRACT

An apparatus for providing presentation of a media collection may include a processing element. The processing element may be configured to receive a selection of a first attribute and a second attribute, and arrange multimedia content for display on a grid having a first axis corresponding to the first attribute and a second axis corresponding to the second attribute.

### TECHNOLOGICAL FIELD

Embodiments of the present invention relate generally to content management technology and, more particularly, relate to a method, device, mobile terminal and computer program product for providing presentation of a media collection.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. As mobile electronic device capabilities expand, a corresponding increase in the storage capacity of such devices has allowed users to store very large amounts of content on the devices. Given that the devices will tend to increase in their capacity to store content, and given also that mobile electronic devices such as mobile phones often face limitations in display size, text input speed, and physical embodiments of user interfaces (UI), challenges are created in content management. Specifically, an imbalance between the development of stored content capabilities and the development of physical UI capabilities may be perceived.

An example of the imbalance described above may be realized in the context of content management and/or selection. In this regard, for example, if a user has a very large amount of content stored in electronic form, it may be difficult to sort through the content in its entirety either to search for content to render or merely to browse the content. This is often the case because content is typically displayed in a one dimensional list format. As such, only a finite number of content items may fit in the viewing screen at any given time. Scrolling through content may reveal other content items, but at the cost of hiding previously displayed content items. Even though list formats may be arranged based on criteria such as genre, album, artist and so on, users are not typically able to see all their content at once (i.e., on a single screen) and therefore it may be difficult to find or re-discover content that the user has stored. Accordingly, only a minimal or at least partial portion of the collection may be browsed, played or utilized. This may be true whether the collection relates to music, movies, pictures or virtually any type of content.

Thus, it may be advantageous to provide an improved method of presenting a media collection, which may provide improved content management for operations such as searching, playing, editing and/or organizing content.

### BRIEF SUMMARY

A method, apparatus and computer program product are therefore provided to enable presentation of a media collection. In particular, a method, apparatus and computer program product are provided that may enable the display of all content on a single display screen. In an exemplary embodiment, all the content of a particular type or storage location may be displayed on a single display screen. In this regard, for example, the user may specify an attribute corresponding to each one of a pair of perpendicular axes (e.g., an X-axis and a Y-axis). The content may then be automatically sorted and displayed relative to the defined axes on the basis of the specified attributes. In an exemplary embodiment, each content item may have associated metadata corresponding to one or more of various attributes that may be used for organization and display of the content based on the attributes specified by the user. Accordingly, the efficiency of content display, sorting, selection, editing, etc. may be increased and content management for devices such as mobile terminals may be improved.

In one exemplary embodiment, a method of providing presentation of a media collection is provided. The method may include receiving a selection of a first attribute and a second attribute, and arranging multimedia content for display on a grid having a first axis corresponding to the first attribute and a second axis corresponding to the second attribute.

In another exemplary embodiment, a computer program product for providing presentation of a media collection is provided. The computer program product includes at least one computer-readable storage medium having computer-readable program code portions stored therein. The computer-readable program code portions include first and second executable portions. The first executable portion is for receiving a selection of a first attribute and a second attribute. The second executable portion is for arranging multimedia content for display on a grid having a first axis corresponding to the first attribute and a second axis corresponding to the second attribute.

In another exemplary embodiment, an apparatus for providing presentation of a media collection is provided. The apparatus may include a processing element. The processing element may be configured to receive a selection of a first attribute and a second attribute, and arrange multimedia content for display on a grid having a first axis corresponding to the first attribute and a second axis corresponding to the second attribute.

In another exemplary embodiment, an apparatus for providing presentation of a media collection is provided. The apparatus includes means for receiving a selection of a first attribute and a second attribute, and means for arranging multimedia content for display on a grid having a first axis corresponding to the first attribute and a second axis corresponding to the second attribute.

Embodiments of the invention may provide a method, apparatus and computer program product for advantageous employment in content management environments including a mobile electronic device environment, such as on a mobile terminal capable of creating and/or viewing content items and objects related to various types of media. As a result, for example, mobile terminal users may enjoy an improved content management capability and a corresponding improved ability to select and experience content.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a system for providing presentation of a media collection according to an exemplary embodiment of the present invention;

FIG. 4 illustrates an example of a display generated according to an exemplary embodiment of the present invention;

FIG. 5 illustrates another example of a display generated according to an exemplary embodiment of the present invention; and

FIG. 6 is a flowchart according to an exemplary method for providing presentation of a media collection according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

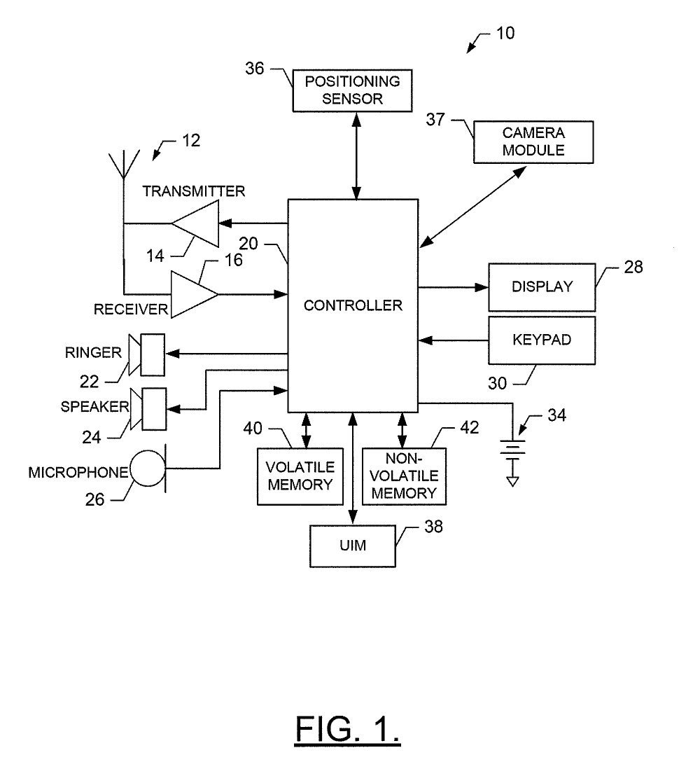

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point. Information from the positioning sensor 36 may then be communicated to a memory of the mobile terminal 10 or to another memory device to be stored as a position history or location information.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

In an exemplary embodiment, the mobile terminal 10 includes a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image. As such, the camera module 37 includes all hardware, such as a lens or other optical device, and software necessary for creating a digital image file from a captured image. Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to a JPEG standard format.

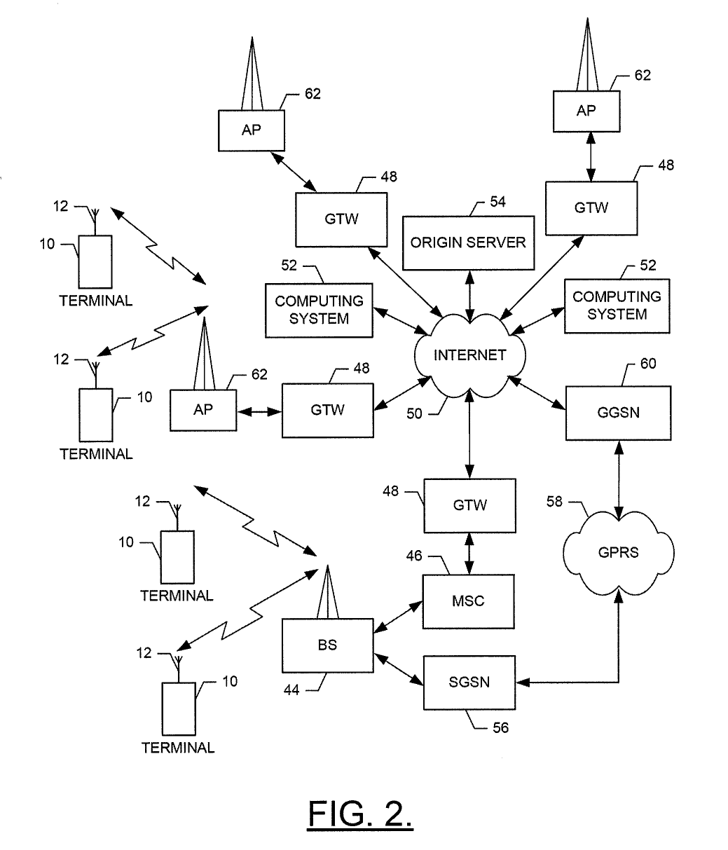

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

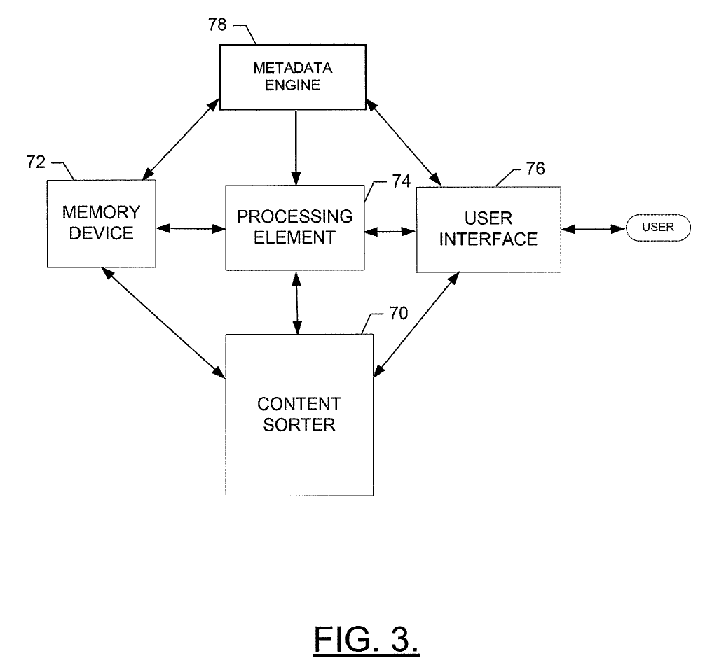

An exemplary embodiment of the invention will now be described with reference to FIG. 3, in which certain elements of a system for providing internationalization of content tagging are displayed. The system of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. For example, the system of FIG. 3 may be employed on a personal computer, a camera, a video recorder, a server, a proxy, etc. Alternatively, embodiments may be employed on a combination of devices including, for example, those listed above. It should also be noted, however, that while FIG. 3 illustrates one example of a configuration of a system for providing media collection presentation, for example, in metadata-based content management, numerous other configurations may also be used to implement embodiments of the present invention.

Referring now to FIG. 3, a system for providing media collection presentation is provided. The system may be embodied in hardware, software or a combination of hardware and software for use by a device such as the mobile terminal. The system may include a content sorter 70, a memory device 72, processing element 74 and a user interface 76. In exemplary embodiments, the content sorter 70, the memory device 72, the processing element 74 and the user interface 76 may be in communication with each other via any wired or wireless communication mechanism. In this regard, for example, the user interface 76 may be in communication with at least the content sorter 70 and/or the processing element 74 to enable the content sorter 70 to generate a display of content stored in the memory device 72 based, for example, on metadata associated with the content. For example, a user may utilize the user interface 76 in order to direct the operation of a device (e.g., the mobile terminal 10) to import a file such as a multimedia file, capture an image or an audio/video sequence, download web content, etc., to thereby create a content item, which may have associated metadata that can be used to define a location of display of the content item on a display such as a two dimensional grid described in greater detail below.

It should be noted that any or all of the content sorter 70, the memory device 72, the processing element 74 and the user interface 76 may be collocated in a single device. For example, the mobile terminal 10 of FIG. 1 may include all of the content sorter 70, the memory device 72, the processing element 74 and the user interface 76. Alternatively, any or all of the content sorter 70, the memory device 72, the processing element 74 and the user interface 76 may be disposed in different devices. For example, the content sorter 70, the processing element 74 and/or the memory device 72 may be disposed at a server, while the user interface 76 may be disposed at a mobile terminal in communication with the server. Other configurations are also possible. In other words, embodiments of the present invention may be executed in a client/server environment as well as or instead of operation on a single device. As such, for example, in an embodiment where the memory device 72 is located at a server, the mobile terminal 10 may view content sorted and presented based on metadata stored or otherwise accessible to the mobile terminal 10 while the content associated with the metadata is actually stored at the memory device of the server. Thus, upon selection of a particular content item at the mobile terminal 10, the particular content item may be streamed or otherwise communicated to the mobile terminal from the server.

In an exemplary embodiment, the system may also include a metadata engine 78, which may be embodied as or otherwise controlled by the processing element 74. The metadata engine 78 may be configured to assign metadata to each created object for storage in association with the created content item in, for example, the memory device 72. In an exemplary embodiment, the metadata engine 78 may be in simultaneous communication with a plurality of applications and may generate metadata for content created by each corresponding application. Examples of applications that may be in communication with the metadata engine may include, without limitation, multimedia generation, phonebook, document creation, calendar, gallery, messaging client, location client, calculator and other like applications. Alternatively, or additionally, content may be received from other devices by file transfer, download, or any other mechanism, such that the received content includes corresponding metadata.

The metadata engine 78 may be any device or means embodied in either hardware, software, or a combination of hardware and software configured to generate metadata according to a defined set of rules. The defined set of rules may dictate, for example, the metadata that is to be assigned to content created using a particular application or in a particular context, etc. As such, in response to receipt of an indication of event such as taking a picture or capturing a video sequence (e.g., from the camera module 37), the metadata engine 78 may be configured to assign corresponding metadata (e.g., a tag).

Metadata typically includes information that is separate from an object, but related to the object. An object may be “tagged” by adding metadata to the object. As such, metadata may be used to specify properties or characteristics associated with the object that may not be obvious from the object itself. Metadata may then be used to organize the objects to improve content management capabilities. Additionally, some methods have been developed for inserting metadata based on context. Context metadata describes the context in which a particular content item was “created”. Hereinafter, the term “created” should be understood to be defined such as to encompass also the terms captured, received, and downloaded. In other words, content is defined as “created” whenever the content first becomes resident in a device, by whatever means regardless of whether the content previously existed on other devices. Context metadata can be associated with each content item in order to provide an annotation to facilitate efficient content management features such as searching and organization features. Accordingly, the context metadata may be used to provide an automated mechanism by which content management may be enhanced and user efforts may be minimized.

Metadata or tags are often textual keywords used to describe the corresponding content with which they are associated. In various examples, the metadata could be static in that the metadata may represent fixed information about the corresponding content such as, for example, date/time of creation or release, genre, title information (e.g., album, movie, song, or other names), tempo, origin information (e.g., artist, content creator, download source, etc.). Alternatively, the metadata could be dynamic in that the metadata may represent variable information associated with the content such as, for example, the last date and/or time at which the content was rendered, the frequency at which the content has been rendered over a defined period of time, popularity of the content (e.g. using sales information or hit rate information related to content), ratings, etc. Title information, origin information may be displayed, for example, in alphabetical order. Date/time related information may be presented in timeline order. Frequency, popularity, ratings, tempo and other information may be presented on a scale from infrequent to frequent, unpopular to popular, low to high, slow to fast, respectively, or vice versa.

The memory device 72 (e.g., the volatile memory 40 or the non-volatile memory 42) may be configured to store a plurality of content items and associated metadata and/or other detailed information (e.g., a narrative describing the content) for each of the content items. The memory device 72 may store content items of either the same or different types. In an exemplary embodiment, different types of content items may be stored in separate folders or separate portions of the memory device 72. However, content items of different types could also be commingled within the memory device 72. For example, one folder within the memory device 72 could include content items related to types of content such as movies, music, broadcast/multicast content, images, video/audio content, etc. Alternatively, separate folders may be dedicated to each type of content. In an exemplary embodiment, a user may utilize the user interface 76 to directly access content stored in the memory device 72, for example, via the processing element 74. The processing element 74 may be in communication with or otherwise execute an application configured to display, play or otherwise render selected content via the user interface 76. However, as described above, navigation through the content of the memory device 72 would typically be via list navigation. Accordingly, exemplary embodiments of the present invention include the content sorter 70, as described in greater detail below, to provide a mechanism by which to view all content (or at least all content, for example, within a particular folder or storage location) at the same time.

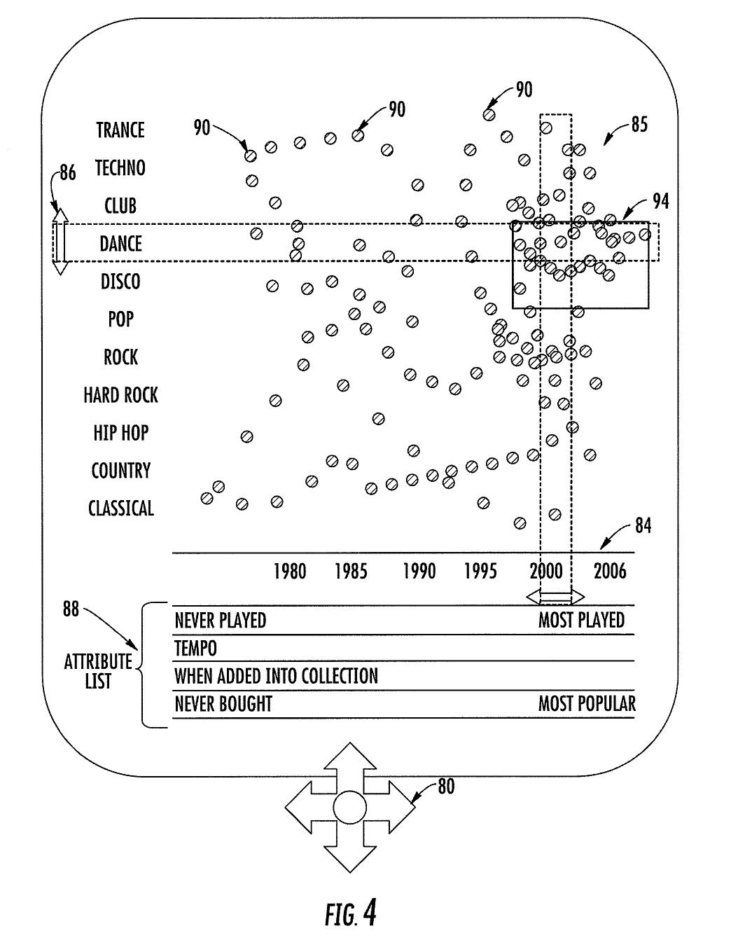

The user interface 76 may include, for example, the keypad 30 and/or the display 28 and associated hardware and software. It should be noted that the user interface 76 may alternatively be embodied entirely in software, such as may be the case when a touch screen is employed for interface using functional elements such as software keys accessible via the touch screen using a finger, stylus, etc. Alternatively, proximity sensors may be employed in connection with a screen such that an actual touch need not be registered in order to perform a corresponding task. Speech input could also or alternatively be utilized in connection with the user interface 76. As another alternative, the user interface 76 may include a simple key interface including a limited number of function keys, each of which may have no predefined association with any particular text characters. As such, the user interface 76 may be as simple as a display and one or more keys for selecting a highlighted option on the display for use in conjunction with a mechanism for highlighting various menu options on the display prior to selection thereof with the one or more keys. For example, the key may be a four way scroller 80 as shown in FIG. 4. User instructions for the performance of a function may be received via the user interface 76 and/or an output such as by visualization of data may be provided via the user interface 76.

The content sorter 70 may be embodied as any device or means embodied in either hardware, software, or a combination of hardware and software that is capable of performing the corresponding functions of the content sorter 70 as described in greater detail below. In an exemplary embodiment, the content sorter 70 may be controlled by or otherwise embodied as the processing element 74 (e.g., the controller 20 or a processor of a computer other device). Processing elements such as those described herein may be embodied in many ways. For example, the processing element may be embodied as a processor, a coprocessor, a controller or various other processing means or devices including integrated circuits such as, for example, an ASIC (application specific integrated circuit).

In an exemplary embodiment, the content sorter 70 may be configured to receive an input, for example, via the user interface 76 defining a first attribute and a second attribute. Attributes such as the first and second attribute may define properties or characteristics which may correlate to metadata associated with each content item. For example, attributes may include information such as date and/or time of creation or release, tempo, genre, title or origin information, the last date and/or time at which the content was rendered, the frequency at which the content has been rendered over a defined period of time, popularity of the content, etc. The content sorter 70 may then be configured to arrange content for display on a grid having a first axis corresponding to the first attribute and a second axis corresponding to the second attribute.

For example, as shown in FIG. 4, which illustrates an example of a display generated according to an exemplary embodiment of the present invention, date of release may be selected as the first attribute along the X-axis 84 and genre may be selected as the second attribute along the Y-axis 86 via four way scroller 80 or any other suitable element of the user interface 76. In an exemplary embodiment, selection of the first and second attributes may be performed via, for example, a user interface console as a prerequisite to generating a content collection presentation display according to an embodiment of the present invention. Alternatively, a menu option may be selected to enable entry of the first and second attributes. As shown in FIG. 4, the first and second attributes may be selected from a list 88 of possible attributes. As also shown in FIG. 4, a segment of one or both of the X-axis position and the Y-axis position corresponding to the position of a cursor manipulated using the four way scroller 80 may each be highlighted. It should be noted that although FIG. 4 only illustrates the use of one quadrant defined by X and Y axes, it is possible to define the attributes to extend over multiple quadrants. As such, the user or the system may provide for definition of the attributes as they relate to the axes in order to utilized desired quadrants of the grid defined by the defined axes.

The content sorter 70 may be configured to access metadata and/or other information associated with each content item in a particular storage location (e.g., in a particular folder or portion of the memory device 72) to determine how to arrange each content item for display relative to the X and Y axes. Based on the characteristics of each content item with respect to the defined attributes, the content sorter 70 may provide information, for example, to the processing element 74 to enable display of a graphical element representing each of the corresponding content items at a position of a grid 85 defined by the X and Y axes corresponding to the respective metadata of each content item. Thus, as further shown in FIG. 4, the content sorter 70 may enable display of graphical elements 90 corresponding to each content item in a collection of content items so that all content items of the collection may be displayed on a single screen.

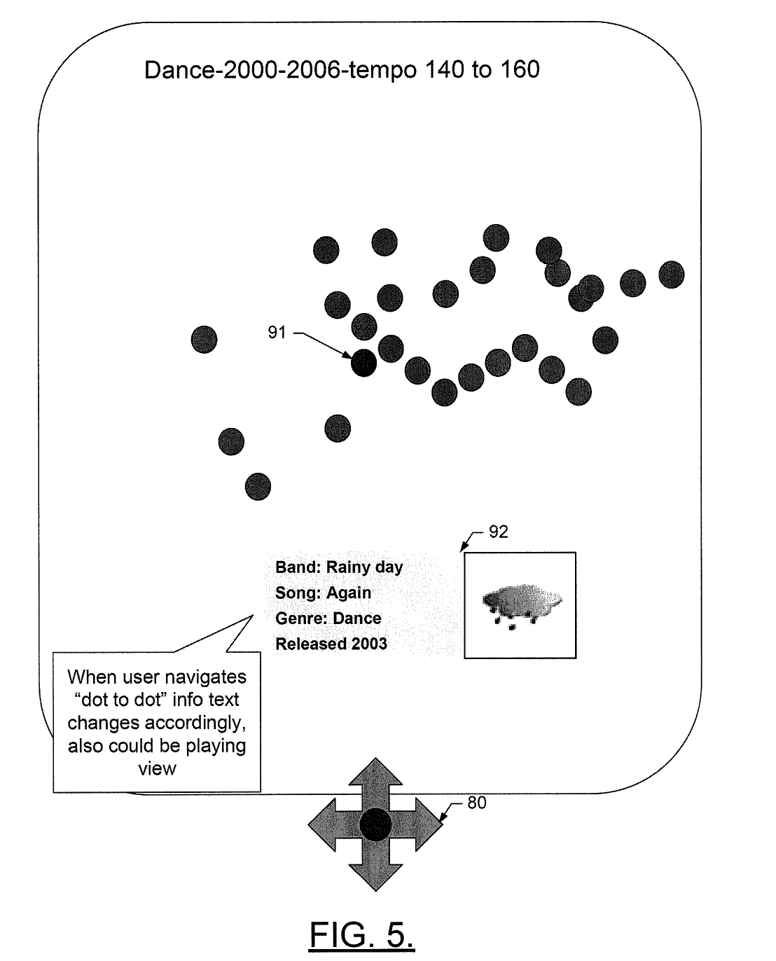

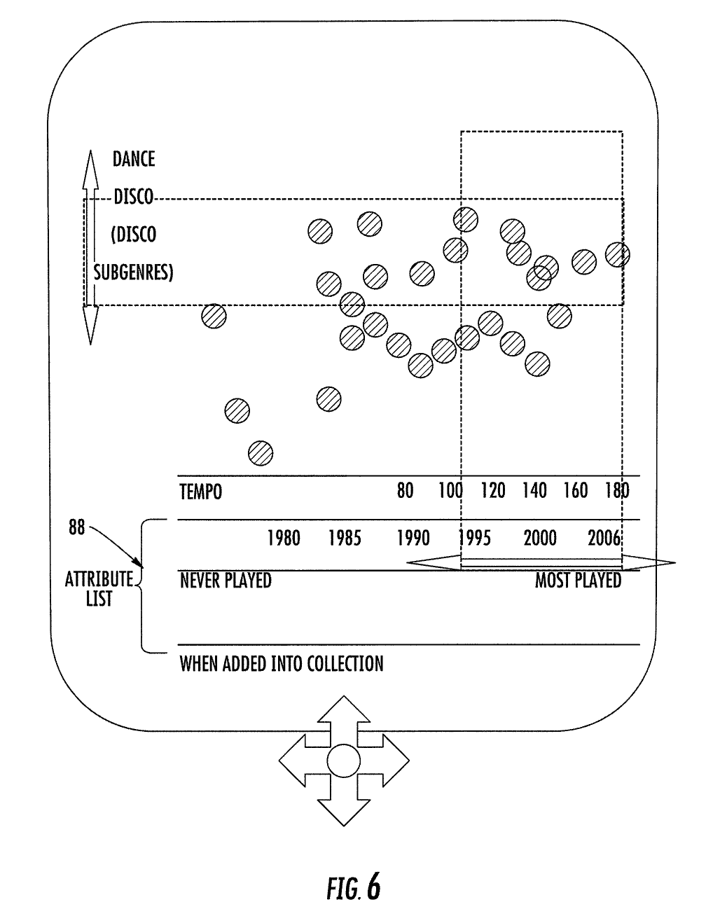

The graphical elements 90 may be “dots” or any other graphical representation of a corresponding content item. As such, each content item, perhaps based on associated metadata (e.g., attributes or characteristics of the corresponding content item), may have a corresponding graphic. For example, the graphic may be a thumbnail image, an album cover graphic, a logo, a numeral, letter or text character, or any other graphic. The graphic may be associated with the type of content (e.g., a record graphic for music, a movie reel for a movie, etc.) or may be indicative of the genre or other characteristics of the content item. The graphical elements 90 could be colored and/or sized according to a particular attribute (e.g., artist, record label, genre or various other attributes). In an exemplary embodiment, as shown in FIG. 5, when a particular content item is selected (such as by moving a cursor over the content item, or clicking on the content item), more detailed information about the content item (possibly including a graphic descriptive of the content) may be displayed, for example, in a pop-up window 92. Although, as also shown in FIG. 5, more detailed information may also be presented at other portions of the display. As an alternative, a further user interface element may be presented in response to selection of a particular content item. In this regard, for example, the further user interface element may be a console or pop-up window showing a representation of the particular content item and related other content items. For example, the particular content item could be disposed prominently, such as in the center of the user interface element, and the related other content items may be disposed around the center or in some other less prominent manner. As an example, after selection of the particular content item, an album cover corresponding to the particular content item may be displayed in the center and album covers of related other content items may be disposed around the particular content item. The related other content items may be related, for example, by virtue of sharing an attribute with the particular content item or by virtue of their location with respect to the particular content item on the generated display. Accordingly, rather than navigating to other content items using only the graphical elements 90 themselves on the display, the user may select the particular content item and navigate to nearby content using the further user interface element. The further user interface element could be placed, for example, in an empty location of the display or could be displayed, for example, with an opacity of less than 100%.

The user may browse through all of the content items and, if desired, perform any of a plurality of functions with respect to one or more of the content items. For example, in response to selection of a particular content item 91, the user may be presented with options for functions to be performed. In an exemplary embodiment, such options may be accessed via the pop-up window 92 or via another mechanism. Examples of functions that may be performed include, playing, rendering, deleting, modifying, moving or copying content to another folder, device or storage location, etc. As such, the user may experience an enhanced capability with respect to the content management of an entire collection from a single screen.

If desired, the user may select a third attribute in order to replace one of the first or second attributes and the grid may be updated accordingly. In this regard, any number of changes of the attributes associated with the X and Y axes may be performed. As another alternative, the user may define a particular portion of the grid to be displayed in order to view a “zoomed in” portion of the grid. In this regard, for example, the user may define (e.g., by a click-and-drag operation) a rectangular or other shaped portion of the grid for redefining a portion of the grid to be displayed. As shown in FIG. 4, a selection window 94 may be defined to establish limits on which portions of the X and Y axes should be displayed (and which corresponding content within the selected portion should be displayed). In other words, the selection window 94 may define a portion of the content items, rather than all of the content items, to be displayed. As an alternative or additional feature, for a particular attribute that has defined segments along a length of the corresponding axis (e.g., genre may be segmented into “dance”, “rock”, etc., segments), one segment may be selected and, in response to selection of the segment, only content within the selected segment may be displayed on a revised display. In essence, the selection window 94 according to an example in which a segment is selected may have the same boundaries for one attribute and the selected segment may define boundaries for the selection window 94 with respect to the other attribute. As such, content items may be filtered with respect to the new boundaries defined for the selection window 94 and the display may be updated correspondingly.

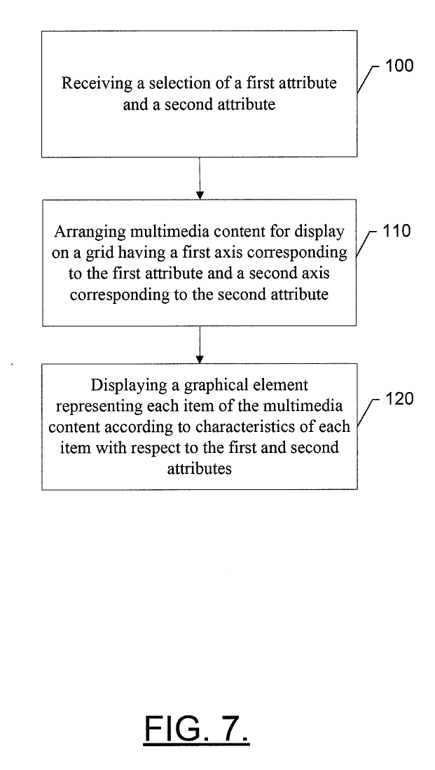

FIG. 6 illustrates a “zoomed in” version of the display of FIG. 4. As illustrated in FIG. 6, the boundaries of the grid of FIG. 6 correspond to the boundaries of the selection window 94 of FIG. 4. As also illustrated in FIG. 6, in an exemplary embodiment, when the “zoomed in” view is shown, it may be possible to show sub-regions (e.g., sub-genres) within a particular attribute.

In an exemplary embodiment, content within the selection window 94 may be added to or otherwise may define a playlist. In order to prevent different types of content from being in the same playlist, in an exemplary embodiment the content sorter 70 may be configured to sort for display only a single type of content. In other words, content in a particular folder or storage location may be filtered by content type and only a single content type may be displayed at any given time. However, content type could alternatively be considered an attribute in certain embodiments or content of all types may be displayed on a single screen with respect to two other attributes. In this regard, in response to selection of each different corresponding type of content item, a respective application for rendering the corresponding type of content item may be executed by the processing element 74.

In some situations, such as where a user has been very active over a short period either recently or when a newly purchased device is placed into service, large amounts of content items may be created or played in a short time that would otherwise appear at an extreme boundary of the grid in response to an attribute selection corresponding to date/time of content creation or rendering. Accordingly, in such situations, it may be possible to select an origin and/or outer limit offset for either or both of the axes so that more content may be displayed away from edges of the display in order to permit easier viewing of the content.

FIG. 7 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing presentation of a media collection as illustrated, for example, in FIG. 7 may include receiving a selection of a first attribute and a second attribute at operation 100. At operation 110, multimedia content may be arranged for display on a grid having a first axis corresponding to the first attribute and a second axis corresponding to the second attribute. In an exemplary embodiment, operation 110 may include sorting the multimedia content based on metadata associated with corresponding items of the multimedia content. The method may further include operation 120 in which, a graphical element is displayed representing each item of the multimedia content according to characteristics of each item with respect to the first and second attributes. In this regard, operation 120 may include displaying a graphic associated with at least one of the first attribute or the second attribute. Alternatively or additionally, operation 120 may include displaying detailed information about a particular content item in response to user selection of the graphical element associated with the particular content item. In an exemplary embodiment, a user selection of a type of multimedia content may be received in which arranging the multimedia content comprises sorting all multimedia content of the selected type.

The method may alternatively include an additional operation of receiving user input defining boundaries for selecting a particular portion of the grid. Accordingly, only corresponding content items within the selected particular portion of the grid may be displayed. In an exemplary embodiment, content within the selected particular portion of the grid may be used to create or otherwise define a playlist. In other exemplary embodiments, the method may further include receiving user input defining a content management function to be performed on a selected content item and/or receiving a user selection of at least a third attribute to replace one of the first attribute or the second attribute and displaying content based on the replacement.

It should be noted that although exemplary embodiments discuss content, the content may include objects or items such as, without limitation, image related content items, video files, television broadcast data, text, documents, web pages, web links, audio files, radio broadcast data, broadcast programming guide data, location tracklog information, etc.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving a selection of a first attribute and a second attribute; and
arranging multimedia content for display on a grid having a first axis corresponding to the first attribute and a second axis corresponding to the second attribute.

2. A method according to claim 1, wherein arranging the multimedia content comprises sorting the multimedia content based on metadata associated with corresponding items of the multimedia content.

3. A method according to claim 1, further comprising receiving a user selection of a type of multimedia content and wherein arranging the multimedia content comprises sorting all multimedia content of the selected type.

4. A method according to claim 1, further comprising displaying a graphical element representing each item of the multimedia content according to characteristics of each item with respect to the first and second attributes.

5. A method according to claim 4, wherein displaying the graphical element comprises displaying a graphic associated with at least one of the first attribute or the second attribute.

6. A method according to claim 4, further comprising displaying detailed information about a particular content item in response to user selection of the graphical element associated with the particular content item.

7. A method according to claim 1, further comprising receiving user input defining boundaries for selecting a particular portion of the grid.

8. A method according to claim 7, further comprising displaying only corresponding content items within the selected particular portion of the grid.

9. A method according to claim 7, further comprising creating a playlist including content in the selected particular portion of the grid.

10. A method according to claim 1, further comprising receiving user input defining a content management function to be performed on a selected content item.

11. A method according to claim 1, further comprising receiving a user selection of at least a third attribute to replace one of the first attribute or the second attribute and displaying content based on the replacement.

12. A computer program product comprising at least one computer-readable storage medium having computer-readable program code portions stored therein, the computer-readable program code portions comprising:
a first executable portion for receiving a selection of a first attribute and a second attribute; and
a second executable portion for arranging multimedia content for display on a grid having a first axis corresponding to the first attribute and a second axis corresponding to the second attribute.

13. A computer program product according to claim 12, wherein the second executable portion includes instructions for sorting the multimedia content based on metadata associated with corresponding items of the multimedia content.

14. A computer program product according to claim 12, further comprising a third executable portion for receiving a user selection of a type of multimedia content and wherein the second executable portion includes instructions for sorting all multimedia content of the selected type.

15. A computer program product according to claim 12, further comprising a third executable portion for displaying a graphical element representing each item of the multimedia content according to characteristics of each item with respect to the first and second attributes.

16. A computer program product according to claim 15, wherein the third executable portion includes instructions for displaying a graphic associated with at least one of the first attribute or the second attribute.

17. A computer program product according to claim 15, further comprising a fourth executable portion for displaying detailed information about a particular content item in response to user selection of the graphical element associated with the particular content item.

18. A computer program product according to claim 12, further comprising a third executable portion for receiving user input defining boundaries for selecting a particular portion of the grid.

19. A computer program product according to claim 18, further comprising a fourth executable portion for displaying only corresponding content items within the selected particular portion of the grid.

20. A computer program product according to claim 18, further comprising a fourth executable portion for creating a playlist including content in the selected particular portion of the grid.

21. A computer program product according to claim 12, further comprising a third executable portion for receiving user input defining a content management function to be performed on a selected content item.

22. A computer program product according to claim 12, further comprising a third executable portion for receiving a user selection of at least a third attribute to replace one of the first attribute or the second attribute and displaying content based on the replacement.

23. An apparatus comprising a processing element configured to:
receive a selection of a first attribute and a second attribute; and
arrange multimedia content for display on a grid having a first axis corresponding to the first attribute and a second axis corresponding to the second attribute.

24. An apparatus according to claim 23, wherein the processing element is further configured to sort the multimedia content based on metadata associated with corresponding items of the multimedia content.

25. An apparatus according to claim 23, wherein the processing element is further configured to receive a user selection of a type of multimedia content and sort all multimedia content of the selected type.

26. An apparatus according to claim 23, wherein the processing element is further configured to display a graphical element representing each item of the multimedia content according to characteristics of each item with respect to the first and second attributes.

27. An apparatus according to claim 26, wherein the processing element is further configured to display a graphic associated with at least one of the first attribute or the second attribute.

28. An apparatus according to claim 26, wherein the processing element is further configured to display detailed information about a particular content item in response to user selection of the graphical element associated with the particular content item.

29. An apparatus according to claim 23, wherein the processing element is further configured to receive user input defining boundaries for selecting a particular portion of the grid.

30. An apparatus according to claim 29, wherein the processing element is further configured to display only corresponding content items within the selected particular portion of the grid.

31. An apparatus according to claim 29, wherein the processing element is further configured to create a playlist including content in the selected particular portion of the grid.

32. An apparatus according to claim 23, wherein the processing element is further configured to receive user input defining a content management function to be performed on a selected content item.

33. An apparatus according to claim 23, wherein the processing element is further configured to receive a user selection of at least a third attribute to replace one of the first attribute or the second attribute and displaying content based on the replacement.

34. An apparatus comprising:
means for receiving a selection of a first attribute and a second attribute; and
means for arranging multimedia content for display on a grid having a first axis corresponding to the first attribute and a second axis corresponding to the second attribute.

35. An apparatus according to claim 34, further comprising means for displaying a graphical element representing each item of the multimedia content according to characteristics of each item with respect to the first and second attributes.
